(19) United States
(12) Patent Application Publication
(10) Pub. No.: US 2008/0307422 A1
(43) Pub. Date: Dec. 11, 2008

(54) SHARED MEMORY FOR MULTI-CORE PROCESSORS

(76) Inventors: Aaron S. Kurland, Lexington, MA (US); Hiroyuki Kataoka, Chelmsford, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/134,716

(22) Filed: Jun. 6, 2008

Related U.S. Application Data
(60) Provisional application No. 60/942,896, filed on Jun. 8, 2007.

(51) Int. Cl. G06F 15/76; G06F 9/02; G06F 9/46

(52) U.S. Cl. 718/102; 712/28; 712/E09.002

(57) ABSTRACT

A shared memory for multi-core processors. Network components configured for operation in a multi-core processor include an integrated memory that is suitable for, e.g., use as a shared on-chip memory. The network component also includes control logic that allows access to the memory from more than one processor core. Typical network components provided in various embodiments of the present invention include routers and switches.

### CROSS-REFERENCE TO RELATED APPLICATIONS

The present application claims the benefit of co-pending U.S. provisional application No. 60/942,896, filed on Jun. 8, 2007, the entire disclosure of which is incorporated by reference as if set forth in its entirety herein.

### FIELD OF THE INVENTION

The present invention relates to microprocessor memories, and in particular to memory shared among a plurality of processor cores.

### BACKGROUND OF THE INVENTION

The computing resources required for applications such as multimedia, networking, and high-performance computing are increasing in both complexity and in the volume of data to be processed. At the same time, it is increasingly difficult to improve microprocessor performance simply by increasing clock speeds, as advances in process technology have currently reached the point of diminishing returns in terms of the performance increase relative to the increases in power consumption and required heat dissipation.

To address the need for higher performance computing, microprocessors are increasingly integrating multiple processing cores. The goal of such multi-core processors is to provide greater performance while consuming less power. In order to achieve high processing throughput, microprocessors typically employ one or more levels of cache memory that are embedded in the chip to reduce the access time for instructions and data. These caches are referred to as Level 1, Level 2, and so on based on their relative proximity to the processor cores.

In multi-core processors, the embedded cache memory architecture must be carefully considered as caches may be dedicated to a particular processor core, or shared among multiple cores. Furthermore, multi-core processors typically employ a more complex interconnect mechanism to connect the cores, caches, and external memory interfaces that often includes switches and routers. In a multi-core processor, cache coherency must also be considered. Multi-core processors may also require that on-chip memory be used as a temporary buffer to share data among multiple processors, as well as to store temporary thread context information in a multi-threaded system.

Given the unique needs and architectural considerations for embedded memory and caches on a multi-core processor, it is desirable to have an on-chip memory mechanism and associated methods to provide an optimum on-chip shared memory for multi-core processors to improve performance and usability, while optimizing power consumption.

### SUMMARY OF THE INVENTION

The present invention addresses the need for on-chip memory in multi-core processors by integrating memory with the network components, e.g., the routers and switches, that make up the processor's on-chip interconnect. Integrating memory directly with interconnect components provides several advantages: (a) low latency access for cores that are directly connected to the router/switch, (b) reduced interconnect traffic by keeping accesses with directly connected nodes local, (c) easily shared memory across multiple cores which may or may not be directly connected to the router/switch, (d) a memory that can be used as a Level 1 cache if the cores themselves have no cache, or as Level 2 cache if the cores already have a Level 1 cache, and (e) a memory that can be configured for use as a cache memory, shared memory, or context store. The memory may be configured to support a memory coherency protocol which can transmit coherency information on the interconnect. In this case too, it is advantageous from a traffic efficiency perspective to have the memory integrated into the fabric of the interconnect, i.e., with the routers/switches.

By reducing latency for memory access by the cores, embodiments of the present invention improve overall system performance. By providing an easily shareable on-chip memory with efficient access, embodiments of the present invention provide for improved inter-core communications in a multi-core microprocessor. Furthermore, embodiments of the present invention can reduce data traffic on the interconnect, thereby reducing overall power consumption.

In one aspect, embodiments of the present invention provide a semiconductor device having a plurality of processor cores and an interconnect comprising a network component, wherein the network component comprises a random access memory and associated control logic that implement a shared memory for a plurality of processor cores.

In one embodiment, the network component is a router or switch. The plurality of processor cores may be heterogeneous or homogenous. The processor cores may be interconnected in a network, such as an optical network. In another embodiment, the semiconductor device also includes a thread scheduler. In still another embodiment, the semiconductor device includes a plurality of peripheral devices.

In another aspect, embodiments of the present invention provide a network component configured for operation in the interconnect of a multi-core processor. The component includes integrated memory and at least one controller allowing access to said memory from a plurality of processor cores. The component may be, for example, a router or a switch. In various embodiments the memory is suitable for use as a shared Level 1 cache memory, a shared Level 2 cache memory, or shared on-chip memory used by a plurality of processor cores.

In one embodiment, the integrated memory is used to stored thread context information by a processor core that is switching between the execution of multiple threads. In a further embodiment, the component comprises a dedicated thread management unit controlling the switching of threads. In another embodiment, the controller implements and executes a memory coherency function.

In still another embodiment, the component further includes routing logic for determining the disposition of data or command packets received from processor cores or peripheral devices. In various embodiments, the integrated memory may be controlled by software running on the processor cores, or a thread management unit.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 is a block diagram of an embodiment of the present invention providing shared memory in a multi-core environment;

FIG. 2 is a block diagram of an embodiment of the thread management unit;

FIG. 3 is a block diagram of a network component having integrated memory in accord with the present invention; and

FIG. 4 is a depiction of a network component having integrated memory in accord with the present invention providing shared memory to several processor cores.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

### Architecture

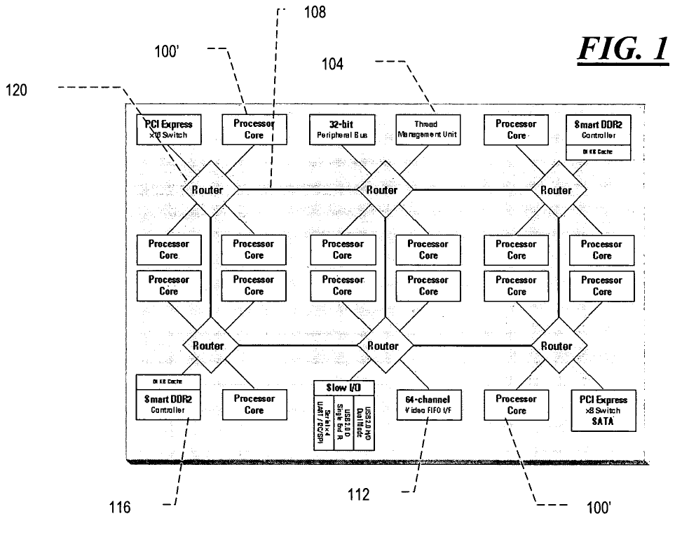

With reference to FIG. 1, a typical embodiment of the present invention includes at least two processing units 100, a thread-management unit 104, an on-chip network interconnect 108, and several optional components including, for example, function blocks 112, such as external interfaces, having network interface units (not explicitly shown), and external memory interfaces 116 having network interface units (again, not explicitly shown). Each processing unit 100 has a microprocessor core and a network interface unit. The processor core may have a Level 1 cache for data or instructions.

The network interconnect 108 typically includes at least one router or switch 120 and signal lines connecting the router or switch 120 to the network interface units of the processing units 100 or other functional blocks 112 on the network. Using the on-chip network fabric 108, any node, such as a processor 100 or functional block 112, can communicate with any other node. In a typical embodiment, communication among nodes over the network 108 occurs in the form of messages sent as packets which can include commands, data, or both.

This architecture allows for a large number of nodes on a single chip, such as the embodiment presented in FIG. 1 having sixteen processing units 100. The large number of processing units allows for a higher level of parallel computing performance. The implementation of a large number of processing units on a single integrated circuit is permitted by the combination of the on-chip network architecture 108 with the out-of-band, dedicated thread-management unit 104.

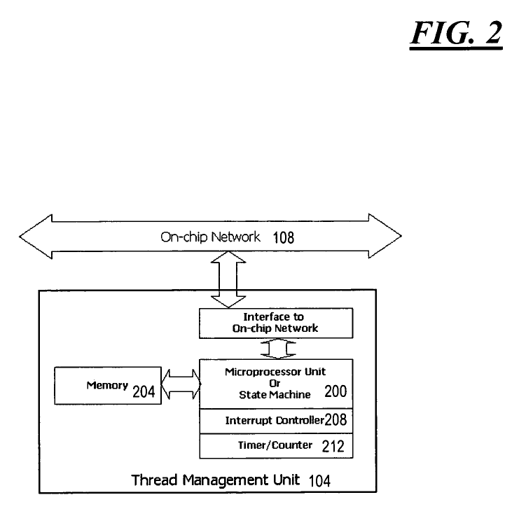

As depicted in FIG. 2, embodiments of the thread-management unit 104 typically include a microprocessor core or a state machine 200, dedicated memory 204, and a network interface unit 208.

### Integrated Memory

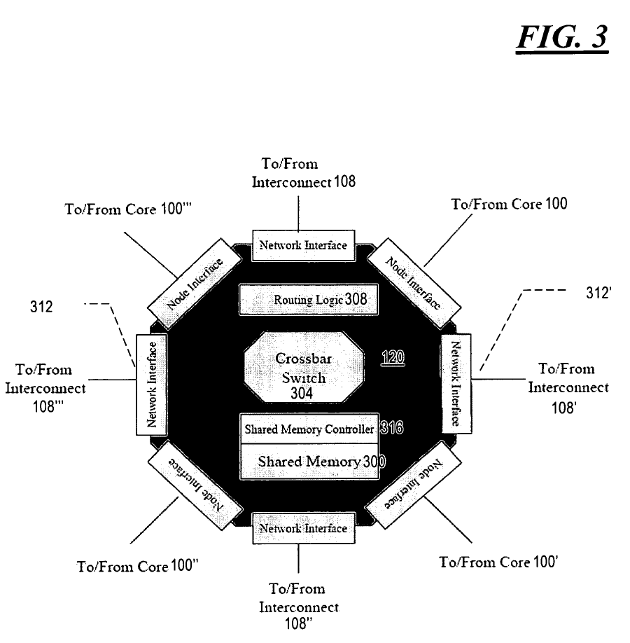

With reference to FIG. 3, various embodiments of the present invention integrate a random access memory 300 with one or more of the routers or switches 120 that comprise the architecture's interconnect 108. This integrated memory 300 can then be used as a cache memory, shared memory, or a context buffer by the processor cores 100 in the system. The memory may be physically embedded inside the circuit for the router or switch 120, or it may be external but connected to the router or switch 120 using a direct connection.

As illustrated, a random access memory 300 is integrated with a router or switch 120 and can then be directly accessed by the nodes that are directly connected to the router or switch 120. The memory 300 may also be accessed indirectly through the interconnect 108 by a node which is connected to a different router or switch. The router or switch 120 also contains a crossbar switch 304 and routing and switching logic 308. Input and output to the router or switch 120 is via interfaces 312 that connect either to another router or switch 120 or to a node such as a processor core 100. Routing logic 308 determines whether an incoming packet should go to the memory controller 316 or to another interface 312.

The random access memory 300 has a controller 316 which may perform functions such as cache operations, locking and tagging of memory objects, and communication to other memory sub-systems, which may include off-chip memories (not shown). The controller 316 may also implement a memory coherency mechanism which would notify users of the memory 300, such as processor cores or other memory controllers, of the state of an object in memory 300 when said object's state has changed.

The memory 300 may be used as a cache memory, shared memory, or as a context buffer for storing thread context information. The controller 316 can set the operating mode of the memory 300 to one, two, or all of the modes.

When operating as a cache memory, the memory 300 can be used as a shared Level 1 cache if the processor cores do not have their own Level 1 caches, or as a Level 2 cache in the case that the processor cores have Level 1 caches.

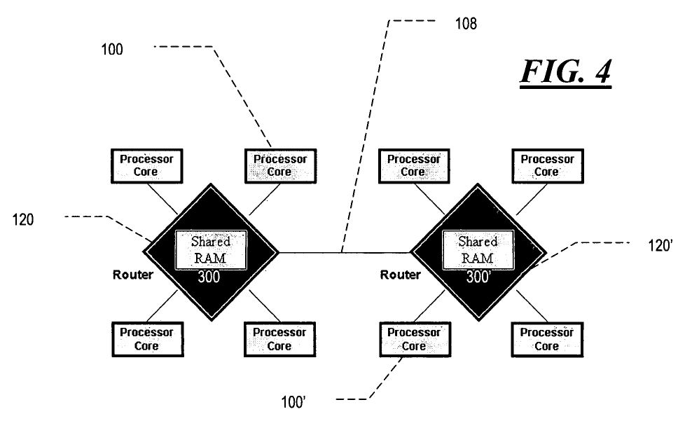

FIG. 4 presents a typical embodiment of a multi-core processor having memory in accord with the present invention. As illustrated, the shared RAM 300, 300′ is shared locally among the processor cores 100 that are directly connected to the router or switch 120. This provides for low latency access resulting in improved performance. Since the memory 300 is shared among a plurality of processor cores 100, the usage of memory space can be optimized for efficiency.

When the memory 300 is operated as shared memory, processor cores 100 under software control can temporarily store data in the memory 300 to be read or modified by another processor core 100′. This sharing of data may be controlled directly by software running on each of the processor cores 100, 100′ or may be further simplified by having access controlled by a separate thread management unit (not shown).

On multi-core processors with a thread management unit, a processor core may be required to switch between execution of multiple software threads. In such cases, the processor core may use the shared memory on the router or switch as a temporary store for thread context data such as the contents of a processor core's registers for a particular thread. The context data is copied to the shared memory before execution of a new thread begins, and is retrieved when the processor core resumes execution of the prior thread. In some cases, the processor core may store contexts for multiple threads, the number of possible stored contexts being only limited by the available amount of memory.

It will therefore be seen that the foregoing represents a highly advantageous approach to a shared memory for use with a multi-core microprocessor. The terms and expressions employed herein are used as terms of description and not of limitation and there is no intention, in the use of such terms and expressions, of excluding any equivalents of the features shown and described or portions thereof, but it is recognized that various modifications are possible within the scope of the invention claimed.

What is claimed is:

1. A semiconductor device comprising:
a plurality of processor cores; and
an interconnect comprising a network component,
wherein the network component comprises a random access memory and associated control logic that implement a shared memory for a plurality of processor cores.

2. The semiconductor device of claim 1 wherein the network component is a router or switch.

3. The semiconductor device of claim 1 wherein the plurality of processor cores are homogeneous.

4. The semiconductor device of claim 1 wherein the plurality of processor cores are heterogeneous.

5. The semiconductor device of claim 1 wherein the processor cores are interconnected in a network.

6. The semiconductor device of claim 1 wherein the processor cores are interconnected by an optical network.

7. The semiconductor device of claim 1 further comprising a thread scheduler.

8. The semiconductor device of claim 1 further comprising a plurality of peripheral devices.

9. A network component configured for operation in the interconnect of a multi-core processor, the component comprising:
integrated memory; and
at least one controller allowing access to said memory from a plurality of processor cores.

10. The component of claim 8 wherein the component is a router or switch.

11. The component of claim 8 wherein the integrated memory is used as a shared Level 1 cache memory.

12. The component of claim 8 wherein the integrated memory is used as a shared Level 2 cache memory.

13. The component of claim 8 wherein the integrated memory is used as shared on-chip memory by a plurality of processor cores.

14. The component of claim 8 wherein the integrated memory is used to store thread context information by a processor core that is switching between the execution of multiple threads.

15. The component of claim 8 wherein the controller implements and executes a memory coherency function.

16. The component of claim 13 further comprising a dedicated thread management unit controlling the switching of threads.

17. The component of claim 9 further comprising routing logic for determining packet disposition.

18. The component of claim 8 wherein the integrated memory is controlled by software running on the processor cores.

19. The component of claim 8 wherein the integrated memory is controlled by a thread management unit.
